(19) United States
(12) Patent Application Publication
(10) Pub. No.: US 2022/0239613 A1
(43) Pub. Date: Jul. 28, 2022

(54) INFORMATION PROCESSING APPARATUS AND NON-TRANSITORY COMPUTER READABLE MEDIUM STORING COMPUTER PROGRAM

(71) Applicant: FUJIFILM Business Innovation Corp., Tokyo (JP)

(72) Inventor: Kazuhide KOBAYASHI, Kanagawa (JP)

(73) Assignee: FUJIFILM Business Innovation Corp., Tokyo (JP)

(21) Appl. No.: 17/376,078

(22) Filed: Jul. 14, 2021

(30) Foreign Application Priority Data
Jan. 27, 2021 (JP) 2021-010983

(51) Int. Cl. H04L 12/58; G06F 16/18; G06F 16/176

(52) U.S. Cl. CPC H04L 51/08; H04L 51/16; G06F 16/176; G06F 16/1873; H04L 51/10

(57) ABSTRACT

An information processing apparatus includes a processor configured to acquire plural messages posted with respect to one theme, and in a case where a designation of a file registered under the one theme is received from a user, extract at least one message from the plural acquired messages based on a relationship between the designated file and the acquired messages and present the extracted message.

### CROSS-REFERENCE TO RELATED APPLICATIONS

This application is based on and claims priority under 35 USC 119 from Japanese Patent Application No. 2021-010983 filed Jan. 27, 2021.

### BACKGROUND

### (i) Technical Field

The present invention relates to an information processing apparatus and a non-transitory computer readable medium storing a computer program.

### (ii) Related Art

JP2019-128689A discloses an information processing apparatus including a generation section that generates correspondence relationship information between messages using a history of communication performed by associating a document with the messages among a plurality of users, an extraction section that extracts a difference in a case where the document is updated, and a presentation section that searches for the difference from the correspondence relationship information and presents a message based on a search result in the correspondence relationship information.

JP4344605B discloses a mail server that specifies an actual mail transmission address associated with document identification information by referring to a document management database based on the document identification information stored in an information storage region of a document attached to a received mail, stores the actual mail transmission address in a transaction DB in association with the document identification information by numbering the actual mail transmission address using a transaction serial number, and transmits the mail to which the document is attached, to the specified actual mail transmission address.

JP2001-084193A discloses an electronic mail information management method including a mail transfer step of transferring a mail to a specific address decided in correspondence with a recipient address in a case where an electronic mail is received by a user, a management target mail determination step of determining a management target mail based on identification information included in the mail in a case where the mail transferred in the mail transfer step is received, and a management target mail registration step of registering the management target mail determined in the management target mail determination step in a predetermined storage location of a document database.

### SUMMARY

A communication based on a message such as a mail or a chat may be performed between users with respect to a file registered under a certain theme. However, in a case where the number of posted messages is increased, an effort of searching for a message related to the file, for example, a message related to editing of the file performed in the past, from all messages is taken for a user.

Aspects of non-limiting embodiments of the present disclosure relate to an information processing apparatus and a non-transitory computer readable medium storing a computer program that are capable of narrowing down and presenting a message related to a file, compared to a case where a user searches for the message related to the file from all messages.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to acquire a plurality of messages posted with respect to one theme, and in a case where a designation of a file registered under the one theme is received from a user, extract at least one message from the plurality of acquired messages based on a relationship between the designated file and the acquired messages and present the extracted message.

### BRIEF DESCRIPTION OF THE DRAWINGS

Exemplary embodiment(s) of the present invention will be described in detail based on the following figures, wherein:

FIG. 1 is a diagram illustrating a schematic configuration of an information processing system according to an exemplary embodiment of the invention;

FIG. 2 is a block diagram illustrating a hardware configuration of an information processing apparatus;

FIG. 3 is a block diagram illustrating an example of functional configurations of the information processing apparatus;

FIG. 4 is a block diagram illustrating an example of functional configurations of a server;

FIG. 5 is an example of information stored in a message storage unit;

FIG. 6 is an example of information stored in a file storage unit;

FIG. 7 is an example of information stored in a user information storage unit;

FIG. 8 is a flowchart illustrating a flow of message presentation process performed by the information processing apparatus;

FIG. 9 is a diagram illustrating an example of a user interface presented on an information display apparatus by the information processing apparatus;

FIGS. 10A to 10D are diagrams illustrating presentation examples of messages in a message display region by the information processing apparatus;

FIG. 11 is a diagram illustrating an example of the user interface presented on the information display apparatus by the information processing apparatus;

FIG. 12 is a diagram illustrating an example of the user interface presented on the information display apparatus by the information processing apparatus;

FIGS. 13A and 13B are diagrams illustrating examples of the user interface presented on the information display apparatus by the information processing apparatus;

FIG. 14 is a diagram illustrating an example of the user interface presented on the information display apparatus by the information processing apparatus; and

FIGS. 15A and 15B are diagrams illustrating examples of the user interface presented on the information display apparatus by the information processing apparatus.

### DETAILED DESCRIPTION

Hereinafter, an example of an exemplary embodiment of the present disclosure will be described with reference to the drawings. In each drawing, identical or equivalent constituents and parts are designated by identical reference signs. In addition, dimensional ratios in the drawings are exaggerated for convenience of description and may be different from actual ratios.

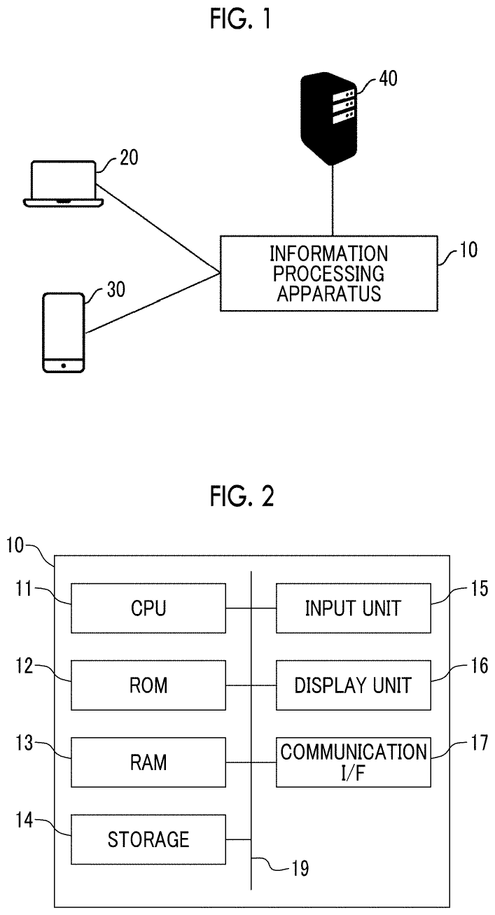

FIG. 1 is a diagram illustrating a schematic configuration of an information processing system according to the exemplary embodiment. The information processing system illustrated in FIG. 1 manages a file in which document data is recorded. The document data may include text data and image data. In addition, the information processing system illustrated in FIG. 1 manages a communication between users based on a message such as a mail or a chat.

The information processing system according to the exemplary embodiment includes an information processing apparatus 10, information display apparatuses 20 and 30, and a server 40.

The information processing apparatus 10 processes information in the information processing system. In a case where any one file stored in the server 40 is designated by a user using the information display apparatuses 20 and 30, the information processing apparatus 10 according to the exemplary embodiment extracts at least one message related to the designated file and presents the extracted message on the information display apparatuses 20 and 30. A specific configuration of the information processing apparatus 10 will be described in detail later.

The information display apparatuses 20 and 30 are devices that display the file and a content of the communication managed by the information processing system and are, for example, personal computers, smartphones, or tablet terminals.

The server 40 stores the file and the communication managed by the information processing system. In addition, the server 40 stores information about a user who uses the information processing system.

While only one server 40 is illustrated in FIG. 1, each server corresponding to stored information may be individually disposed. That is, each of a server storing the file, a server storing the communication, and a server storing user information may be disposed.

FIG. 2 is a block diagram illustrating a hardware configuration of the information processing apparatus 10.

As illustrated in FIG. 2, the information processing apparatus 10 includes a central processing unit (CPU) 11, a read only memory (ROM) 12, a random access memory (RAM) 13, a storage 14, an input unit 15, a display unit 16, and a communication interface (I/F) 17. These configurations are communicably connected to each other through a bus 19.

The CPU 11 is a central calculation processing unit and executes various programs or controls each unit. That is, the CPU 11 reads a program from the ROM 12 or the storage 14 and executes the program using the RAM 13 as a work region. The CPU 11 controls each configuration and performs various calculation processes in accordance with the program recorded in the ROM 12 or the storage 14. In the exemplary embodiment, the ROM 12 or the storage 14 stores a message presentation program for extracting at least one message related to the designated file and presenting the extracted message on the information display apparatuses 20 and 30.

The ROM 12 stores various programs and various types of data. The RAM 13 temporarily stores a program or data as the work region. The storage 14 is configured with a storage apparatus such as a hard disk drive (HDD), a solid state drive (SSD), or a flash memory and stores various programs including an operating system and various data.

The input unit 15 includes a pointing device such as a mouse and a keyboard, and is used for providing various inputs.

The display unit 16 is, for example, a liquid crystal display and displays various information. The display unit 16 may function as the input unit 15 by employing a touch panel type.

The communication interface 17 is an interface for communicating with another apparatus such as the information display apparatuses 20 and 30 and uses standards such as Ethernet (registered trademark), FDDI, and Wi-Fi (registered trademark).

In a case of executing an information processing program described above, the information processing apparatus 10 implements various functions using hardware resources described above. Functional configurations implemented by the information processing apparatus 10 will be described.

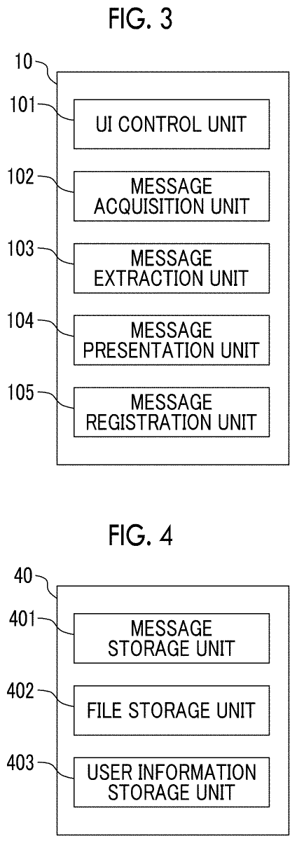

FIG. 3 is a block diagram illustrating an example of functional configurations of the information processing apparatus 10.

As illustrated in FIG. 3, the information processing apparatus 10 includes, as the functional configurations, a user interface (UI) control unit 101, a message acquisition unit 102, a message extraction unit 103, a message presentation unit 104, and a message registration unit 105. Each functional configuration is implemented by causing the CPU 11 to read and execute the message presentation program stored in the ROM 12 or the storage 14.

The UI control unit 101 performs a control related to a content of a user interface presented on the information display apparatuses 20 and 30. An example of the user interface presented on the information display apparatuses 20 and 30 by the UI control unit 101 will be described later.

The message acquisition unit 102 acquires a message that is posted with respect to one theme. The theme refers to a management unit of files and, for example, includes, but not limited to, a folder storing one or more files and a region (also referred to as a workspace) in which files are shared.

In a case where a designation of a file registered under one theme is received from the user, the message extraction unit 103 extracts at least one message from a plurality of messages based on a relationship between the designated file and the message acquired by the message acquisition unit 102.

For example, in a case of extracting the message, the message extraction unit 103 may extract a message that has an explicit relationship with the designated file. As the message having the explicit relationship with the designated file, the message extraction unit 103 may extract a message to which the designated file is attached. In addition, as the message having the explicit relationship with the designated file, the message extraction unit 103 may extract a message in which a storage destination of the designated file is written.

In extraction of the message, in a case where a plurality of versions are present for the designated file, the message extraction unit 103 may extract a message related to a version of the designated file and also a message related to a version different from the version.

In a case where the message having the explicit relationship with the designated file is not present, the message extraction unit 103 may calculate a relevance degree between the designated file and the acquired message and extract a message of which the calculated relevance degree is higher than a predetermined threshold. In a case of calculating the relevance degree, the message extraction unit 103 may calculate the relevance degree based on an updated date and time of the designated file and a posted date and time of the acquired message. Specifically, the message extraction unit 103 may calculate the relevance degree of the message such that the relevance degree is increased as the posted date and time of the message is closer to the updated date and time of the designated file.

In addition, the message extraction unit 103 may calculate the relevance degree based on the designated file and a keyword in the acquired message. For example, in a case where the keyword in the acquired message includes a content indicating that the file has been created, updated, or deleted, or a content implying that these operations have been performed, the message extraction unit 103 may calculate a higher relevance degree than other messages. In addition, the message extraction unit 103 may calculate the relevance degree based on the designated file and information about the user in the acquired message. For example, in a case where a user who has edited the designated file matches a sender in the message, the message extraction unit 103 may calculate a higher relevance degree than the other messages.

In a case where a history of the file is selected by the user, the message extraction unit 103 may extract a message related to the selected history. For example, the message extraction unit 103 may extract the message based on a date and time of the history and the posted date and time of the message. In addition, in a case where the file is document data, and a text or an annotation in the document is selected by the user, the message extraction unit 103 may extract a message related to the selected text or the annotation.

The message presentation unit 104 causes the UI control unit 101 to present the message extracted by the message extraction unit 103. In a case of presenting the message, the message extracted by the message extraction unit 103 may be presented on the user interface of which display is controlled by the UI control unit 101.

In a case of presenting the message extracted by the message extraction unit 103, the message presentation unit 104 may cause the UI control unit 101 to present the extracted message by tracing the message back to a time point at which the message is posted. Ina case where the message is presented in time series, the message presentation unit 104 can reduce an effort of searching for the message by the user by causing the UI control unit 101 to present the message extracted by the message extraction unit 103 by tracing the message back to the time point at which the message is posted.

In a case of presenting the message extracted by the message extraction unit 103, the message presentation unit 104 may cause the UI control unit 101 to present only the extracted message and a predetermined number of messages that are posted previous and subsequent to the message. By limiting a range of presented messages, the message presentation unit 104 can reduce an effort of searching for contents of the previous and subsequent messages by the user.

In a case of presenting the message extracted by the message extraction unit 103, the message presentation unit 104 may cause the UI control unit 101 to present the extracted message in a different aspect from a non-extracted message. For example, the message presentation unit 104 may cause the UI control unit 101 to present the extracted message and the non-extracted message in different text colors or background colors.

In a case of presenting the message extracted by the message extraction unit 103, the message presentation unit 104 may cause the UI control unit 101 to present the extracted message in a different region from messages including the non-extracted message.

In a case of presenting the message extracted by the message extraction unit 103, the message presentation unit 104 may cause the UI control unit 101 to present the extracted message in a state where the extracted message is stored in an attribute of the designated file. In a case of storing the extracted message in the attribute of the designated file, the message presentation unit 104 may store information about a connection destination such as a URL on which the extracted message is presented, in the attribute of the file or may store the extracted message in the attribute of the file.

The message registration unit 105 registers the message extracted by the message extraction unit 103 in the designated file or a database that is configured to link the extracted message to the designated file. In a case of presenting the message, the message presentation unit 104 presents the message registered by the message registration unit 105.

Next, functional configurations of the server 40 will be described.

FIG. 4 is a block diagram illustrating an example of functional configurations of the server 40.

As illustrated in FIG. 4, the server 40 includes, as the functional configurations, a message storage unit 401, a file storage unit 402, and a user information storage unit 403.

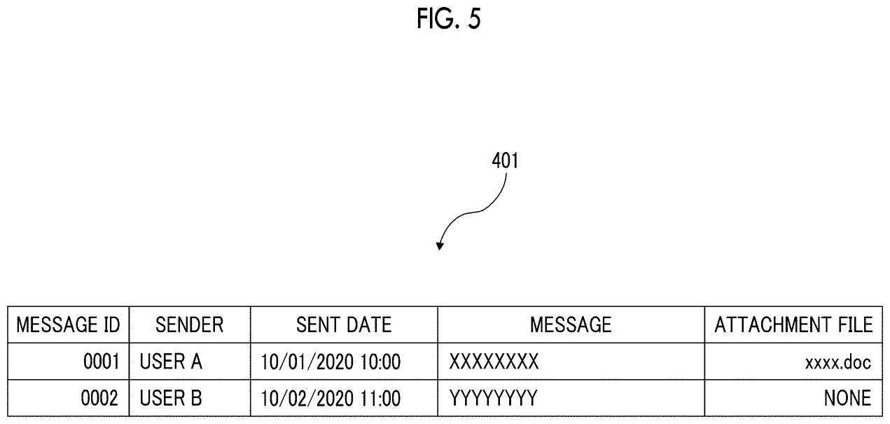

The message storage unit 401 stores messages posted by the user. FIG. 5 is an example of information stored in the message storage unit 401. In FIG. 5, a message ID for identifying a message, a sender of the message, a sent date of the message, a content of the message, and an attached file are illustrated as the information stored in the message storage unit 401. In a field of the sender of the message, a user ID for identifying the user may be stored instead of a user name. In addition, the message storage unit 401 may store information (the user name or the user ID) about a user of a recipient of the message.

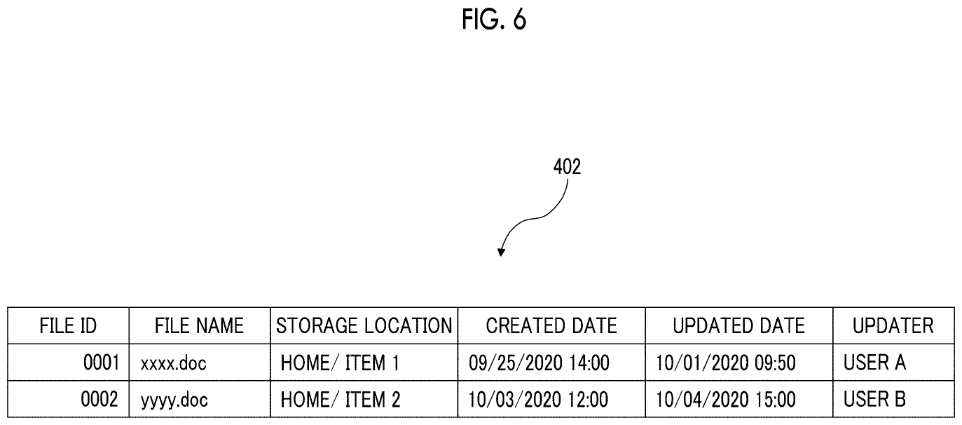

The file storage unit 402 stores information about files stored by the user. FIG. 6 is an example of information stored in the file storage unit 402. In FIG. 6, a file ID for identifying a file, a file name, a created date of the file, an updated date of the file, an updater of the file, and a storage location of the file are illustrated as the information stored in the file storage unit 402. In a field of the updater of the file, the user ID for identifying the user may be stored instead of the user name.

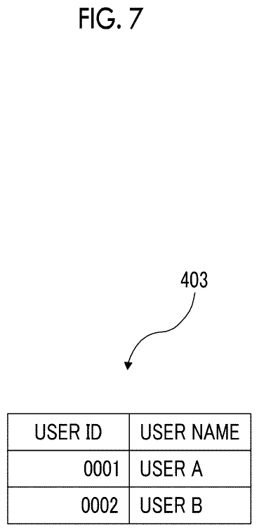

The user information storage unit 403 stores information about the user who uses the information processing system. FIG. 7 is an example of information stored in the user information storage unit 403. In FIG. 7, the user ID for identifying the user and the user name are illustrated as the information stored in the user information storage unit 403.

While an example of including the message storage unit 401, the file storage unit 402, and the user information storage unit 403 in the server 40 is illustrated in the exemplary embodiment, the present invention is not limited to such an example. The message storage unit 401, the file storage unit 402, and the user information storage unit 403 may not be included in an identical apparatus as long as the information processing apparatus 10 can acquire information from each of the message storage unit 401, the file storage unit 402, and the user information storage unit 403.

Next, an action of the information processing apparatus 10 will be described.

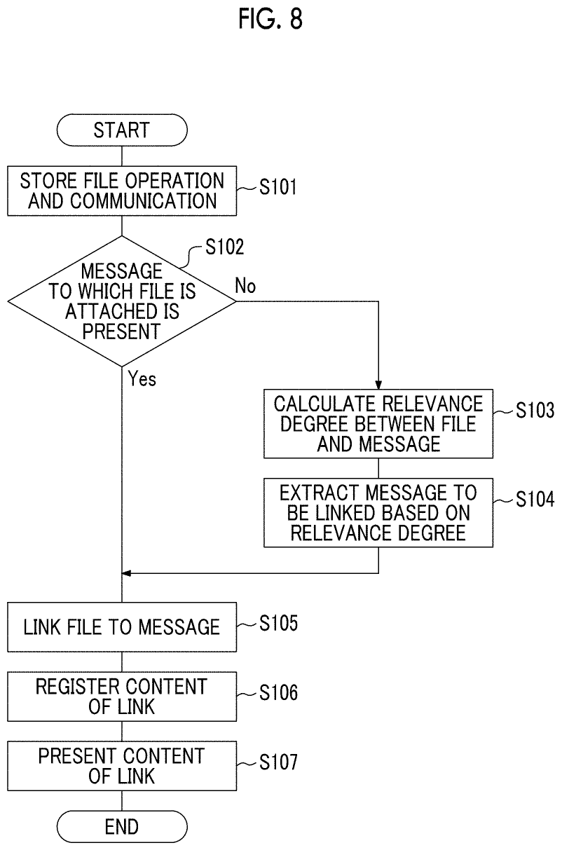

FIG. 8 is a flowchart illustrating a flow of message presentation process performed by the information processing apparatus 10. The message presentation process is performed by causing the CPU 11 to read the message presentation program from the ROM 12 or the storage 14, load the message presentation program into the RAM 13, and execute the message presentation program.

The CPU 11 stores a file operation or the communication of the user in the server 40 (step S101).

Next, in a case of extracting the message related to the file designated by the user, the CPU 11 determines whether or not a message to which the file designated by the user is attached is present in the message storage unit 401 (step S102).

As a result of determination in step S102, in a case where the message to which the file designated by the user is attached is not present in the message storage unit 401 (step S102; No), the CPU 11 calculates the relevance degree between the file designated by the user and the message (step S103). In a case of calculating the relevance degree, the CPU 11 may calculate the relevance degree based on the updated date and time of the designated file and the posted date and time of the acquired message. The CPU 11 may calculate the relevance degree of the message such that the relevance degree is increased as the posted date and time of the message is closer to the updated date and time of the designated file. In addition, the CPU 11 may calculate the relevance degree based on the designated file and the keyword in the acquired message. For example, in a case where the keyword in the acquired message includes the content indicating that the file has been created, updated, or deleted, or the content implying that these operations have been performed, the CPU 11 may calculate a higher relevance degree than other messages. In addition, the CPU 11 may calculate the relevance degree based on the designated file and the information about the user in the acquired message.

After step S103, the CPU 11 extracts a message to be linked to the file based on the relevance degree calculated in step S103 (step S104).

As a result of determination in step S102, in a case where the message to which the file designated by the user is attached is present in the message storage unit 401 (step S102; Yes), the CPU 11 links the file designated by the user to the message to which the file is attached (step S105). In addition, after step S104, the CPU 11 links the file designated by the user to the extracted message (step S105).

After step S105, the CPU 11 registers a content of a link between the file designated by the user and the message in the file designated by the user or the database (step S106).

After step S106, the CPU 11 presents the content of the link between the file designated by the user and the message (step S107).

By executing a series of operations illustrated in FIG. 8, the information processing apparatus 10 may extract at least one message from a plurality of acquired messages based on the relationship between the file designated by the user and the acquired message and present the extracted message. By extracting at least one message from the plurality of acquired messages and presenting the extracted message, the information processing apparatus 10 may reduce the effort of searching for the message by the user, compared to a case where the message is not extracted.

Next, presentation examples of the message by the information processing apparatus 10 will be described.

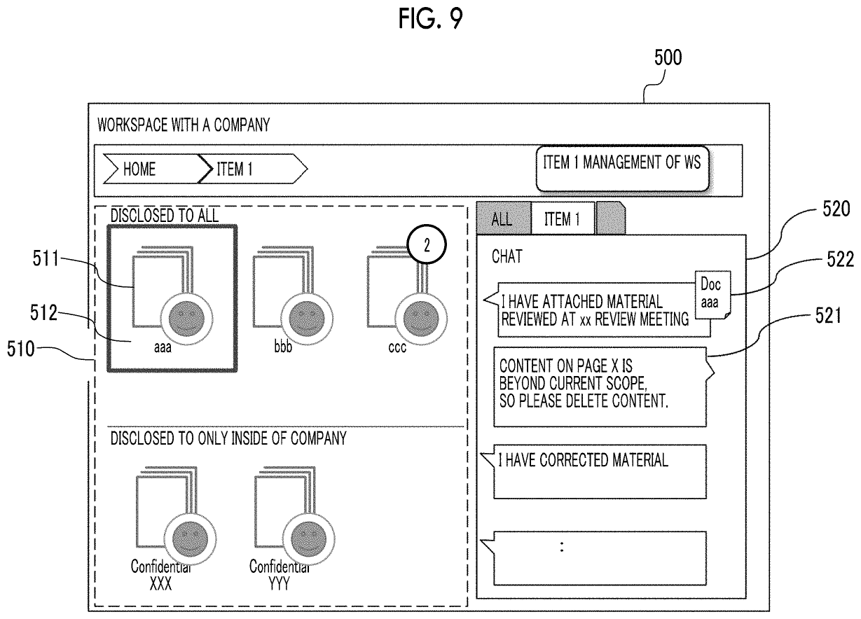

FIG. 9 is a diagram illustrating an example of the user interface presented on the information display apparatuses 20 and 30 by the information processing apparatus 10. A user interface 500 includes a file display region 510 and a message display region 520. A file icon 511 illustrating each individual file and a file name 512 of the file are displayed in the file display region 510. In addition, each individual message 521 is displayed in order of sent date and time in the message display region 520. In a case where an attachment file is present in the message 521, an attachment file icon 522 is displayed in the message 521.

In a case where the user designates the file by selecting the file icon 511 displayed in the file display region 510, the information processing apparatus 10 extracts the message related to the designated file and presents the extracted message in the message display region 520.

As the message related to the designated file, for example, the information processing apparatus 10 presents the message to which the file is attached. In addition, for example, as in an example of “I HAVE CORRECTED MATERIAL”, even though the file is not attached, in a case where a message implying that the file has been updated is posted, the information processing apparatus 10 presents a message that is posted at a time closest to an updated time of the file.

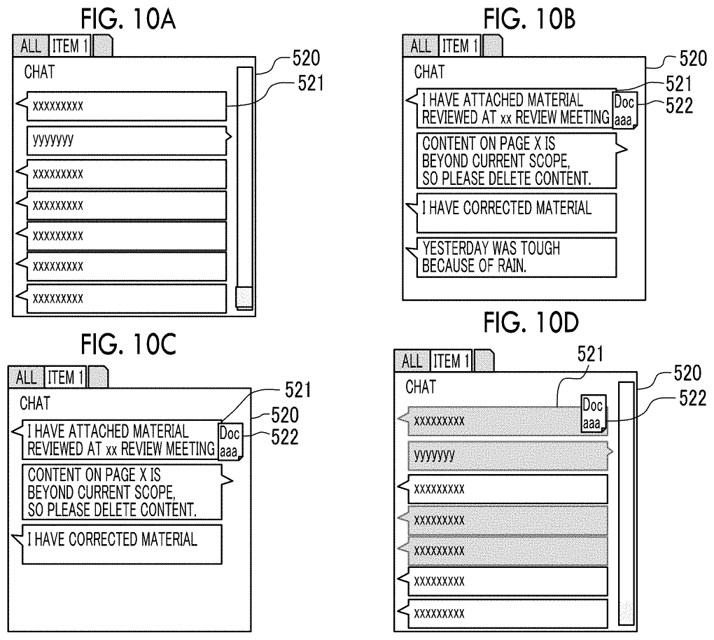

FIGS. 10A to 10D are diagrams illustrating presentation examples of messages in the message display region by the information processing apparatus 10. FIG. 10A is a presentation example in the message display region 520 in a state where the file is not designated by the user.

In a case where the file is designated by the user in a state of FIG. 10A, the information processing apparatus 10, for example, as illustrated in FIG. 10B, presents messages starting from the message linked to the designated file in the message display region 520.

In addition, in a case where the file is designated by the user in the state of FIG. 10A, the information processing apparatus 10, for example, as illustrated in FIG. 10C, may present only the message linked to the designated file and the predetermined number of messages previous and subsequent to the message in the message display region 520.

In addition, in a case where the file is designated by the user in the state of FIG. 10A, the information processing apparatus 10, for example, as illustrated in FIG. 10D, may present the message linked to the designated file in the message display region 520 in a different aspect from the other messages. For example, the different aspect is an aspect of highlighted display of only the message linked to the designated file. The highlighted display includes increasing thickness of the text, changing the text color, changing the background color of the message, and the like.

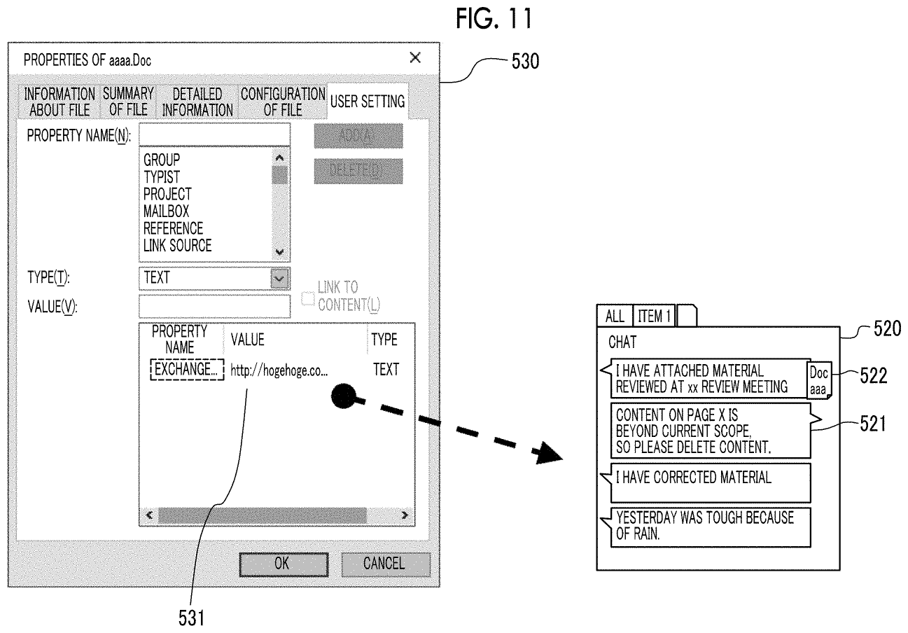

The information processing apparatus 10 may store connection information for presenting the message linked to the file designated by the user in the attribute of the file. FIG. 11 is a diagram illustrating an example of the user interface presented on the information display apparatuses 20 and 30 by the information processing apparatus 10. In FIG. 11, an example of an attribute screen 530 of the file designated by the user is illustrated. As illustrated in FIG. 11, the information processing apparatus 10 may store connection information 531 for presenting the message linked to the file in the attribute of the file. In a case where the user selects the connection information 531, the information processing apparatus 10 presents the message linked to the file designated by the user in the message display region 520.

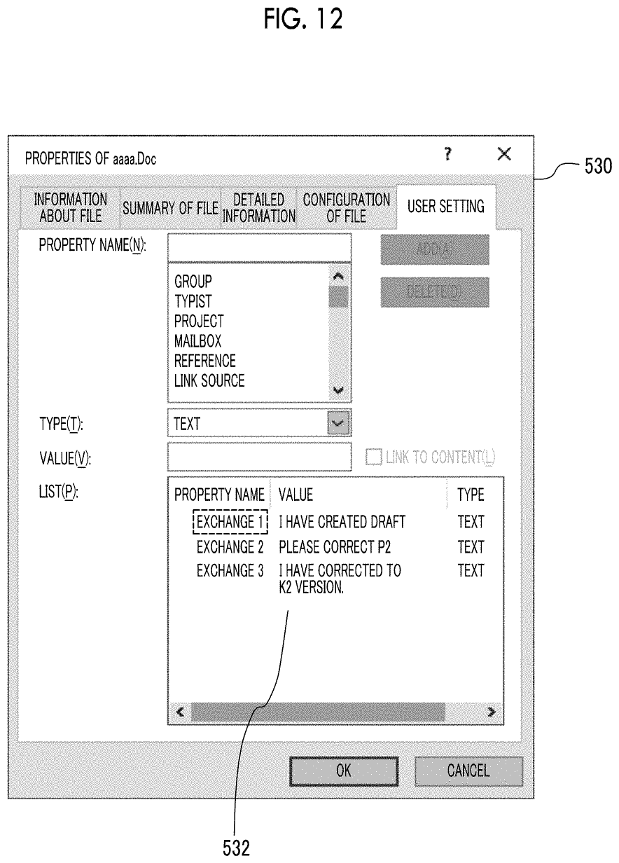

The information processing apparatus 10 may store the content of the message linked to the file designated by the user in the attribute of the file. FIG. 12 is a diagram illustrating an example of the user interface presented on the information display apparatuses 20 and 30 by the information processing apparatus 10. In FIG. 12, an example of the attribute screen 530 of the file designated by the user is illustrated. As illustrated in FIG. 12, the information processing apparatus 10 may store the content of the message in a message region 532 in which the message linked to the file is stored.

The information processing apparatus 10 may analyze the content of the posted message in real time and switch a presentation aspect of the message in accordance with the content of the message. For example, in a case where document names partially match, a case where a keyword related to a document operation such as commenting, pointing out, updating, or correcting is included, or a case where the recipient at a time of posting the document is the same as the recipient of exchange of the message, the information processing apparatus 10 may switch the presentation aspect of related messages to be different from the other messages.

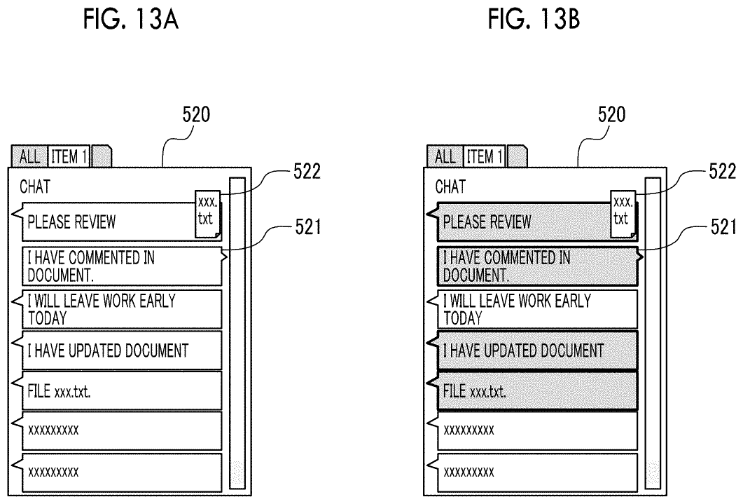

FIGS. 13A and 13B are diagrams illustrating presentation examples of messages by the information processing apparatus 10. FIG. 13A is an example in which the messages 521 posted by the user are presented in the message display region 520 in time series. As in FIG. 13A, the file is attached to the posted messages, the messages include keywords such as “document”, “comment”, and “update”, and a file name such as “xxx.Txt” is included in the messages. The information processing apparatus 10 may present such messages related to the file in the message display region 520 in a different aspect from the other messages as in FIG. 13B.

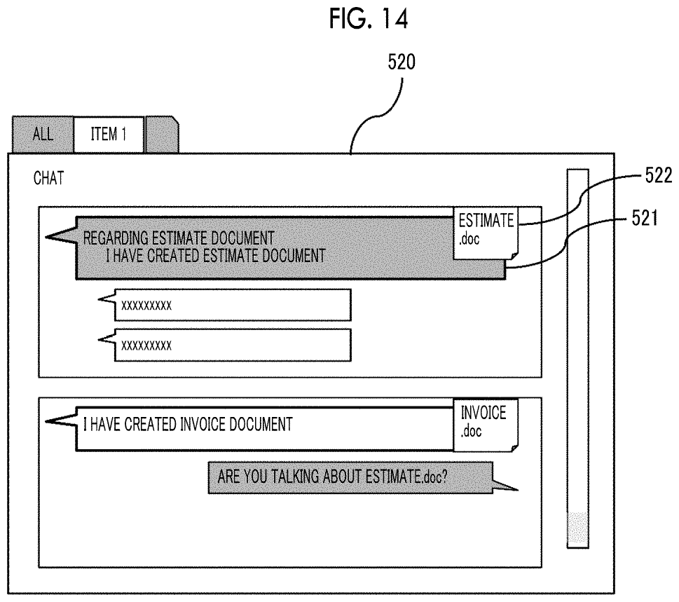

The messages posted by the user may be presented in a thread form. FIG. 14 is a diagram illustrating a presentation example of messages by the information processing apparatus 10. In FIG. 14, an example in which each message 521 is presented in the message display region 520 in a thread form is illustrated. Even in a case where the messages are presented in a thread form, the information processing apparatus 10 may present the messages related to the file in a different aspect from the other messages as illustrated in FIG. 14. In addition, in a case of presenting the messages related to the file, the information processing apparatus 10 may present only a thread including the related messages.

In addition, in a case where the messages are presented in a thread form, sharing the file across threads is also considered. The information processing apparatus 10 may decide a thread to be preferentially presented based on the number of messages of related threads and the relevance degree. For example, in a case where two messages related to the file are present in a thread A, and three messages related to the file are present in a thread B, the information processing apparatus 10 preferentially presents the thread B over the thread A. Preferential presentation of the thread refers to presentation on an upstream side (that is, a side on which older messages are displayed) in a case where the messages are linearly displayed in time series. For example, in a case where the messages are linearly displayed from a top to a bottom in order from the oldest, the preferentially presented thread is presented at an upper position. In addition, for example, in a case where three messages related to the file are present in both of the threads A and B, the information processing apparatus 10 may add up the relevance degree of each message and preferentially present a thread having a higher relevance degree over the other thread.

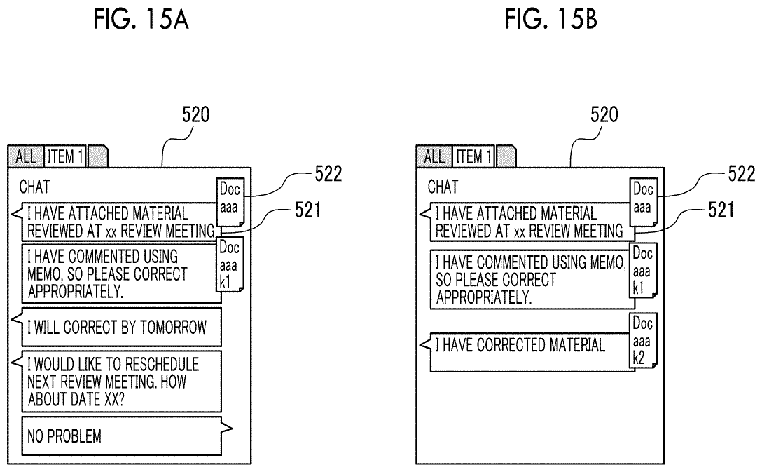

In a case where the file is managed in versions, the information processing apparatus 10 may extract messages related to not only the designated file but also other versions of the file. FIGS. 15A and 15B are diagrams illustrating presentation examples of messages by the information processing apparatus 10. For example, in a case where a file “Docaaa” is designated by the user, the information processing apparatus 10, as illustrated in FIGS. 15A and 15B, may extract messages related to not only the file but also other versions of the file (in the examples in FIGS. 15A and 15B, “Docaaak1” and “Docaaak2”) and present the messages in the message display region 520.

The information processing apparatus 10 may determine whether or not a file is another version of the designated file based on the file name. In a case where different versions of the file are collectively managed as one file, and the user selects one file, the information processing apparatus 10 collectively extracts messages related to each version in the designated file.

The message presentation process executed by causing the CPU to read software (program) in the exemplary embodiment may be executed by various processors other than the CPU. In this case, the processors are illustrated by a programmable logic device (PLD) such as a field-programmable gate array (FPGA) having a circuit configuration changeable after manufacturing, a dedicated electric circuit such as an application specific integrated circuit (ASIC) that is a processor having a circuit configuration dedicatedly designed to execute a specific process, and the like. In addition, the message presentation process may be executed by one of these various processors or may be executed by a combination of two or more processors of the same type or different types (for example, a plurality of FPGAs and a combination of a CPU and an FPGA). In addition, a hardware structure of these various processors is specifically an electric circuit in which circuit elements such as semiconductor elements are combined.

While an aspect in which the program for the message presentation process is prestored (installed) in the ROM or the storage is described in the exemplary embodiment, the present invention is not limited to the aspect. The program may be provided in the form of a recording on a non-temporary (non-transitory) recording medium such as a compact disk read only memory (CD-ROM), a digital versatile disk read only memory (DVD-ROM), and a universal serial bus (USB) memory. In addition, the program may be in the form of a download from an outside apparatus through a network.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to:
acquire a plurality of messages posted with respect to one theme; and
in a case where a designation of a file registered under the one theme is received from a user, extract at least one message from the plurality of acquired messages based on a relationship between the designated file and the acquired messages and present the extracted message.

2. The information processing apparatus according to claim 1, wherein the processor is configured to:
present the extracted message by tracing the message back to a time point at which the extracted message is posted.

3. The information processing apparatus according to claim 2, wherein the processor is configured to:
present only the extracted message and a predetermined number of messages posted previous and subsequent to the message.

4. The information processing apparatus according to claim 1, wherein the processor is configured to:
present the extracted message in a different aspect from a non-extracted message.

5. The information processing apparatus according to claim 4, wherein the processor is configured to:
present the extracted message in a different region from messages including the non-extracted message.

6. The information processing apparatus according to claim 1, wherein the processor is configured to:
store information related to the extracted message in an attribute of the designated file.

7. The information processing apparatus according to claim 6, wherein the processor is configured to:
store information about a connection destination at which the extracted message is presented, in the attribute of the file.

8. The information processing apparatus according to claim 6, wherein the processor is configured to:
store the extracted message in the attribute of the file.

9. The information processing apparatus according to claim 1, wherein the processor is configured to:
in a case where a plurality of versions of the designated file are present, also extract a message related to a version different from a version of the designated file.

10. The information processing apparatus according to claim 1, wherein the processor is configured to:
in a case where a message having an explicit relationship with the designated file is not present, calculate a relevance degree between the file and the acquired messages and extract and present a message of which the calculated relevance degree is higher than a predetermined threshold.

11. The information processing apparatus according to claim 10, wherein the processor is configured to:
calculate the relevance degree based on an updated date and time of the designated file and a posted date and time of the acquired messages.

12. The information processing apparatus according to claim 10, wherein the processor is configured to:
calculate the relevance degree based on the designated file and a keyword in the acquired messages.

13. The information processing apparatus according to claim 10, wherein the processor is configured to:
calculate the relevance degree based on the designated file and information about the user in the acquired messages.

14. The information processing apparatus according to claim 1, wherein the processor is configured to:
extract a message having an explicit relationship with the designated file.

15. The information processing apparatus according to claim 14, wherein the processor is configured to:
extract a message to which the designated file is attached, from the plurality of acquired messages.

16. The information processing apparatus according to claim 14, wherein the processor is configured to:
extract a message in which a storage destination of the designated file is written, from the plurality of acquired messages.

17. A non-transitory computer readable medium storing a computer program causing a computer to execute a process comprising:
acquiring a plurality of messages posted with respect to one theme; and
extracting at least one message from the plurality of acquired messages based on a relationship between the designated file and the acquired messages and presenting the extracted message, in a case where a designation of a file registered under the one theme is received from a user.

18. An information processing apparatus comprising:
means for acquiring a plurality of messages posted with respect to one theme;
means for extracting at least one message from the plurality of acquired messages based on a relationship between the designated file and the acquired messages, in a case where a designation of a file registered under the one theme is received from a user; and
means for presenting the extracted message.
